(19) United States
(12) Patent Application Publication
(10) Pub. No.: US 2025/0265732 A1
(43) Pub. Date: Aug. 21, 2025

(54) CAMERA PARAMETER CALCULATION DEVICE, CAMERA PARAMETER CALCULATION METHOD, AND NON-TRANSITORY COMPUTER READABLE RECORDING MEDIUM

(71) Applicant: Panasonic Intellectual Property Management Co., Ltd., Osaka (JP)

(72) Inventor: Nobuhiko WAKAI, Tokyo (JP)

(21) Appl. No.: 19/201,417

(22) Filed: May 7, 2025

Related U.S. Application Data
(63) Continuation of application No. PCT/JP2023/040439, filed on Nov. 9, 2023.

(30) Foreign Application Priority Data
Nov. 11, 2022 (JP) 2022-180908

(51) Int. Cl. G06T 7/80; G06T 7/33; G06T 7/35

(52) U.S. Cl. CPC G06T 7/80; G06T 7/344; G06T 7/35; G06T 2207/20076; G06T 2207/20081

(57) ABSTRACT

A camera parameter calculation device acquires an image taken by a camera, generates a heatmap representing a likelihood of image principal point at each pixel by inputting the acquired image to a learning model, and calculates a camera parameter of the camera on the basis of the generated heatmap, the learning model being trained by machine learning so as to cause an estimated image principal point indicated by a heatmap to approach a true value for the estimated image principal point.

### FIELD OF INVENTION

The present disclosure relates to a technique of calculating a camera parameter.

### BACKGROUND ART

Non-Patent Literature 1 discloses a technique of calculating a camera parameter by a geometry-based method of associating three-dimensional coordinates in a three-dimensional space with a pixel position of a two-dimensional image by use of a calibration index.

Non-Patent Literature 2 discloses a technique of performing a camera calibration from an image taken by a fisheye camera using deep learning.

Non-Patent Literature 3 discloses a method of performing a camera calibration from an image using deep learning.

In the conventional techniques above, a camera parameter is not estimated on the basis of a distribution of a likelihood of image principal point at each pixel; thus, further improvement is required to estimate the camera parameter with high accuracy.
Non-Patent Literature 1: R. Y. Tsai. “A versatile camera calibration technique for high accuracy 3D machine vision metrology using off-the-shelf TV cameras and lenses”. IEEE Journal of Robotics and Automation, Volume 3, Number 4, pages 323-344, 1987
Non-Patent Literature 2: N. Wakai and T. Yamashita. “Deep Single Fisheye Image Camera Calibration for Over 180-degree Projection of Field of View”, In Proceedings of IEEE/CVF International Conference on Computer Vision Workshop, pages 1174-1183, 2021
Non-Patent Literature 3: K. Liao, C. Lin, and Y. Zhao. “A Deep Ordinal Distortion Estimation Approach for Distortion Rectification”, IEEE Transactions on Image Processing, Volume 30, pages 3362-3375, 2021

### SUMMARY OF THE INVENTION

The present disclosure has been made in view of the above-mentioned problems to provide a technique that enables highly accurate estimation of a camera parameter.

A camera parameter calculation device according to one aspect of the present disclosure includes: an acquisition part for acquiring an image taken by a camera; and a camera parameter calculation part for generating a heatmap representing a likelihood of image principal point at each pixel by inputting the image acquired by the acquisition part to a learning model, and calculating a camera parameter of the camera on the basis of the generated heatmap, wherein the learning model is trained by machine learning so as to cause an estimated image principal point indicated by a heatmap generated from an input training image to approach a true value corresponding to the estimated image principal point.

The present disclosure enables highly accurate estimation of a camera parameter. Consequently, accurate camera calibration can be performed.

### BRIEF DESCRIPTION OF THE DRAWINGS

FIG. 1 is a block diagram showing an exemplary configuration of a camera parameter calculation device according to an embodiment.

FIG. 2 is an illustration for an image principal point.

FIG. 3 is a flowchart showing an exemplary process of calculating the image principal point by the camera parameter calculation device according to the embodiment.

FIG. 4 is a flowchart showing an exemplary training process of the camera parameter calculation device according to the embodiment.

FIG. 5 is an illustration showing an exemplary heatmap.

FIG. 6A is a graph showing an exemplary heatmap in training.

FIG. 6B is a graph showing an exemplary heatmap on completion of the training.

FIG. 7 is a graph showing an exemplary multipeaked heatmap.

### DETAILED DESCRIPTION

Circumstances that Led to the Present Disclosure

A geometry-based method for performing a camera calibration for a sensing camera or the like requires an association of three-dimensional coordinates in a three-dimensional space with a pixel position of a two-dimensional image. This requires accurate calculation of a camera parameter. In this regard, there has been known a technique of associating three-dimensional coordinates and a pixel position of a two-dimensional image with each other by taking an image of a repeating pattern having a known shape and detecting an intersection or a center of a circle for the repeating pattern (Non-Patent Literature 1). There have also been known methods using deep learning as a method of performing a camera parameter calculation robust against image brightness and a subject from an input image (Non-Patent Literature 2, 3).

In Non-Patent Literature 1 to 3, however, an image principal point is not estimated on the basis of a distribution of a likelihood of image principal point at each pixel; therefore, a camera parameter cannot be estimated accurately.

The present disclosure has been made to solve the above-mentioned problems.

(1) A camera parameter calculation device according to one aspect of the present disclosure includes: an acquisition part for acquiring an image taken by a camera; and a camera parameter calculation part for generating a heatmap representing a likelihood of image principal point at each pixel by inputting the image acquired by the acquisition part to a learning model, and calculating a camera parameter of the camera on the basis of the generated heatmap, wherein the learning model is trained by machine learning so as to cause an estimated image principal point indicated by a heatmap generated from an input training image to approach a true value corresponding to the estimated image principal point.

In this configuration, a heatmap representing a likelihood of image principal point at each pixel is output by inputting an image taken by a camera to a learning model, and a camera parameter is calculated on the basis of the heatmap, the learning model being trained by machine learning so as to cause an estimated image principal point indicated by a heatmap showing a distribution of the likelihoods to approach a true value corresponding to the estimated image principal point. This configuration enables accurate estimation of a camera parameter. Consequently, accurate camera calibration can be performed.

(2) The camera parameter calculation device described in (1) above may further include a camera parameter output part for outputting the camera parameter calculated by the camera parameter calculation part.

In this configuration, the camera parameter calculated by the camera parameter calculation part is output. Thus, accurate camera calibration can be performed by use of the output camera parameter.

(3) In the camera parameter calculation device described in (1) or (2) above, the learning model may be trained by machine learning so as to output a heatmap having a concentric distribution of the likelihoods.

This configuration enables training the learning model by machine learning to output a heatmap having a concentric distribution of the likelihoods.

(4) In the camera parameter calculation device described in any one of (1) to (3) above, the learning model may be trained by machine learning so as to minimize a difference between a likelihood at a pixel of interest and an average value of likelihoods at pixels on a circumference of a circle that has a center represented by the true value and passes through the pixel of interest.

In this configuration, a learning model to output a heatmap having a concentric distribution of the likelihoods around a center represented by a true value for an image principal point can be obtained.

(5) The camera parameter calculation device described in any one of (1) to (4) above may further include a heatmap output part for outputting to a display a heatmap output by the learning model which is in the training of the learning model.

After the learning model has been trained sufficiently, the learning model outputs a heatmap having a concentric distribution of the likelihoods. This configuration, in which a heatmap is output from the learning model, enables confirmation as to whether the learning model has been trained by machine learning sufficiently.

(6) In the camera parameter calculation device described in any one of (1) to (5) above, the likelihood may include an image principal point probability or a distortion.

In this configuration, the likelihood is represented by an image principal point probability or an image distortion. Thus, a heatmap accurately representing the likelihoods of image principal point can be obtained.

(7) In the camera parameter calculation device described in any one of (1) to (6) above, the camera parameter may include the image principal point.

This configuration enables calculation of an image principal point as a camera parameter.

(8) A camera parameter calculation method according to another aspect of the present disclosure, by a computer, includes: acquiring an image taken by a camera; and outputting a heatmap representing a likelihood of image principal point at each pixel by inputting the acquired image to a learning model, and calculating a camera parameter of the camera on the basis of the output heatmap, wherein the learning model is trained by machine learning so as to cause an estimated image principal point indicated by a heatmap generated from an input training image to approach a true value corresponding to the estimated image principal point.

This configuration enables provision of a camera parameter calculation method for estimating a camera parameter with high accuracy.

(9) A camera parameter calculation program according to another aspect of the present disclosure causes a computer to execute a process of: acquiring an image taken by a camera; and outputting a heatmap representing a likelihood of image principal point at each pixel by inputting the acquired image to a learning model, and calculating a camera parameter of the camera on the basis of the output heatmap, wherein the learning model is trained by machine learning so as to cause an estimated image principal point indicated by a heatmap generated from an input training image to approach a true value corresponding to the estimated image principal point.

This configuration enables provision of a camera parameter calculation program for estimating a camera parameter with high accuracy.

(10) A storage medium recording a camera parameter calculation program according to another aspect of the present disclosure, the camera parameter calculation program causing a computer to execute a process of: acquiring an image taken by a camera; and outputting a heatmap representing a likelihood of image principal point at each pixel by inputting the acquired image to a learning model, and calculating a camera parameter of the camera on the basis of the output heatmap, wherein the learning model is trained by machine learning so as to cause an estimated image principal point indicated by a heatmap generated from an input training image to approach a true value corresponding to the estimated image principal point.

This configuration enables provision of a storage medium recording a camera parameter calculation program for estimating a camera parameter with high accuracy.

It goes without saying that the storage medium recording the camera parameter calculation program in the present disclosure is distributable as a non-transitory computer readable storage medium like a CD-ROM, or distributable via a communication network like the Internet.

Each of the embodiments which will be described below represents a specific example of the disclosure. Numerical values, shapes, constituents, steps, and the order thereof described below are mere examples, and thus should not be construed to delimit the disclosure. Further, constituents which are not recited in the independent claims each showing the broadest concept among the constituents in the embodiments are described as selectable constituent. The respective contents are combinable with each other in all the embodiments.

### Embodiments

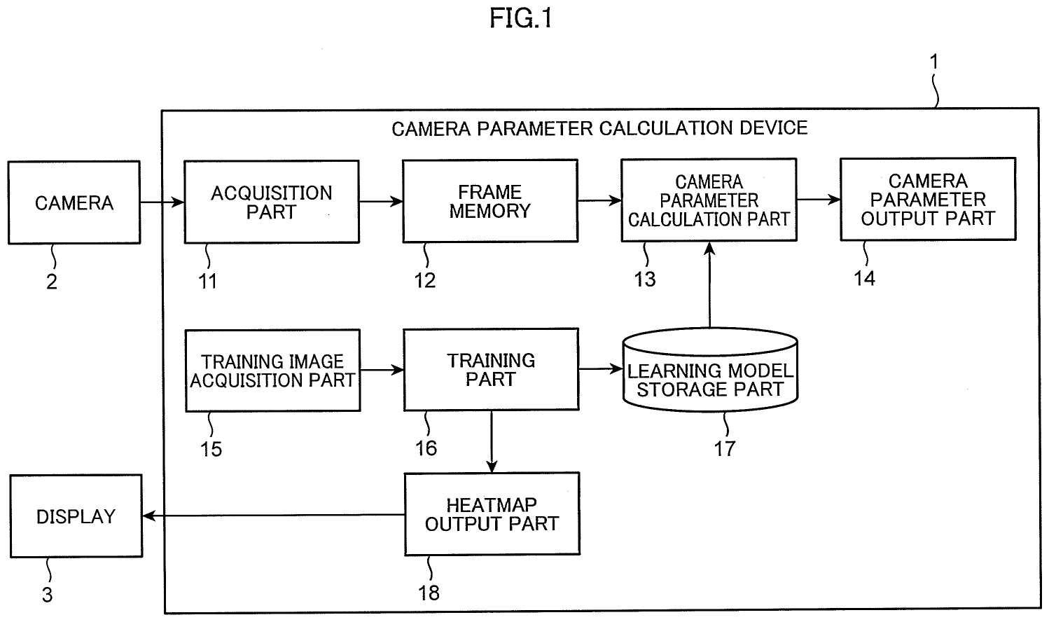

An embodiment of the present disclosure will be described below with reference to the drawings. FIG. 1 is a block diagram showing an exemplary configuration of a camera parameter calculation device 1 according to the embodiment. The camera parameter calculation device 1 includes an acquisition part 11, a frame memory 12, a camera parameter calculation part 13, and a camera parameter output part 14. Further, the camera parameter calculation device 1 includes a training image acquisition part 15, a training part 16, a learning model storage part 17, and a heatmap output part 18.

The camera parameter calculation device 1 includes a computer having, e.g., a processor, a memory, and an interface circuit. The acquisition part 11, the camera parameter calculation part 13, the camera parameter output part 14, the training image acquisition part 15, the training part 16, and the heatmap output part 18 may do performance when the processor executes a camera parameter calculation program prestored in the memory. These components may be constituted by dedicated hardware. The frame memory 12 includes a storage device, e.g., a RAM or a semiconductor memory. The learning model storage part 17 includes a storage device, e.g., a semiconductor memory, a hard disk drive, or a solid state drive.

The camera parameter calculation device 1 is not necessarily constituted by a single computer device, and may be constituted by a distributed processing system (unillustrated) including a terminal device and a server. For example, the terminal device may be provided with the acquisition part 11 and the frame memory 12, and the server may be provided with the camera parameter calculation part 13, the camera parameter output part 14, the training image acquisition part 15, the training part 16, the learning model storage part 17, and the heatmap output part 18. In this case, reception and transmission of data between the constituents are executed through a communication line connected to the terminal device and the server.

The training image acquisition part 15, the training part 16, the learning model storage part 17, and the heatmap output part 18 may be included in a training device having a computer different from that of the camera parameter calculation device 1. In this configuration, the camera parameter calculation device 1 acquires from the training device a learning model trained by the training device.

The acquisition part 11 acquires an image taken by a camera 2. The camera 2 is a camera to take a video, or may be a camera to take a still image. The camera 2 is, e.g., a surveillance camera disposed inside or outside. The camera 2 may be a wide-angle camera, a fisheye camera, or an ordinary camera. In a case where the camera 2 is a fisheye camera, the image is a fisheye image.

The camera 2 and the camera parameter calculation device 1 are connected with each other, for example, via a wireless or wired communication channel (unillustrated). The acquisition part 11 may automatically acquire an image from the camera 2 via the communication channel. Alternatively, the acquisition part 11 may acquire an image taken by the camera 2 in response to an operation input by a user to the camera parameter calculation device 1.

The frame memory 12 stores the image acquired by the acquisition part 11. The camera parameter calculation part 13 reads out the image from the frame memory 12 and inputs the image to a learning model stored in the learning model storage part 17 to thereby calculate a camera parameter.

Specifically, the camera parameter calculation part 13 generates a heatmap representing a likelihood of image principal point at each of a plurality of pixels forming the image by inputting the image read out from the frame memory 12 to the learning model, and calculates the camera parameter of the camera on the basis of the generated heatmap. The likelihood of image principal point is represented by a value indicative of a likelihood that a certain pixel forming the heatmap is an image principal point. In the description below, the likelihood of image principal point is defined as an image principal point probability. The image principal point probability is a probability that a certain pixel forming the heatmap is the image principal point.

The camera parameter includes an extrinsic parameter and an intrinsic parameter of the camera 2. The extrinsic parameter includes, e.g., a parameter indicative of a rotation angle of the camera 2 and a parameter indicative of a translation of the camera 2. The intrinsic parameter of the camera 2 includes, e.g., the image principal point and a pixel pitch. In the description below, the camera parameter calculation part 13 will be described as calculating the image principal point as the camera parameter.

The learning model receives an image as an input and outputs a heatmap. The learning model is trained by machine learning so as to cause an image principal point indicated by a heatmap generated from an input training image (hereinafter, referred to as “estimated image principal point”) to approach a true value corresponding to the estimated image principal point.

The camera parameter output part 14 outputs the camera parameter calculated by the camera parameter calculation part 13. For example, the camera parameter output part 14 outputs the camera parameter to the camera 2, or may output to an external computer or to a memory (unillustrated) included in the camera parameter calculation device 1.

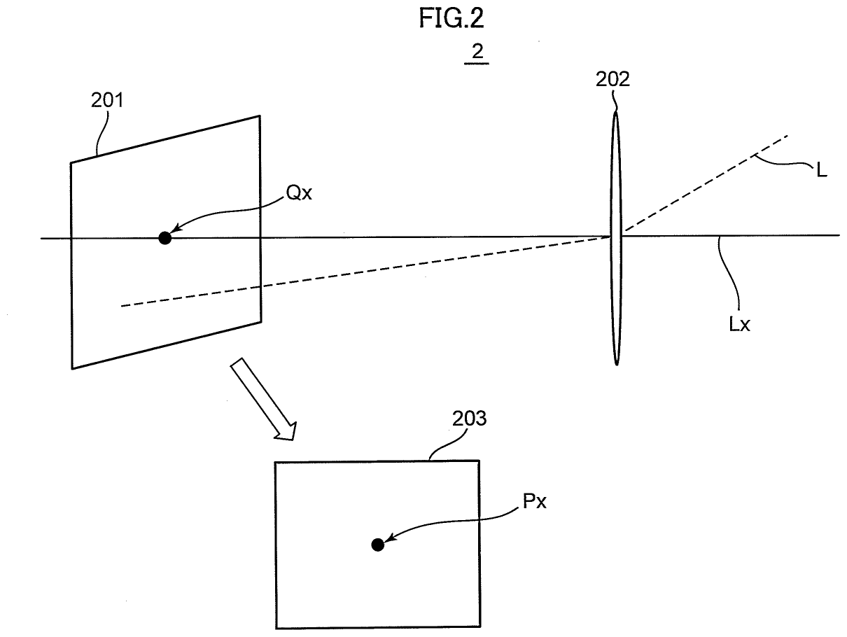

FIG. 2 is an illustration for the image principal point. In FIG. 2, the camera 2 includes an image sensor 201 and a lens 202. The image principal point Px is a point that is on an image 203 and obtained by projection of an intersection Qx of an optical axis Lx of the lens 202 and the image sensor 201. An incident ray L is a ray of light that does not pass through the optical axis Lx and is projected to the image sensor 201 at a position different from that of the image principal point Px. A design value for the image principal point Px represents the center of the image 203, but the image principal point Px may be deviated from the center of the image 203 due to an assembly error. A deviation of the image principal point Px from the center of the image 203 decreases accuracy in a camera calibration of associating a coordinate in a world space with a coordinate in the image sensor 201. Accordingly, in the embodiment, a process of calculating the image principal point is executed to calculate an exact value for the image principal point Px.

The training image acquisition part 15 acquires a training image to be used for training by the training part 16. The training image is associated with a true value for the image principal point. The true value for the image principal point is a coordinate of a true image principal point. The training image acquisition part 15 acquires the training image from, e.g., a database (unillustrated) storing the training image.

The training part 16 performs machine learning using the training image acquired by the training image acquisition part 15 to thereby generate a learning model. The machine learning involves, e.g., a deep neural network, but this is merely an example; a learning model other than the deep neural network may be trained by machine learning. The training part 16 generates a heatmap by inputting the training image to the learning model. The training part 16 executes an error backpropagation so as to cause the estimated image principal point calculated on the basis of the heatmap to approach the true value for the image principal point associated with the training image to thereby generate the learning model. The estimated image principal point calculated on the basis of the heatmap is a pixel having the highest image principal point probability in the heatmap.

The learning model storage part 17 stores the learning model trained by the training part 16.

The heatmap output part 18 outputs to a display 3 a heatmap output by the learning model which is in the training of the learning model.

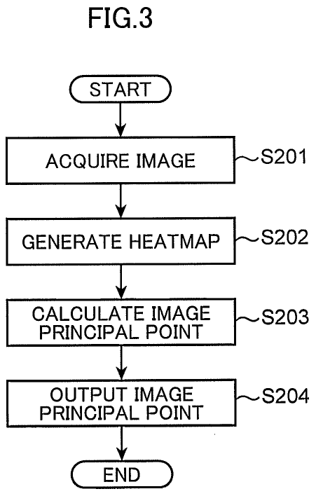

The configuration of the camera parameter calculation device 1 is as described above. Next, a process of the camera parameter calculation device 1 will be described. FIG. 3 is a flowchart showing an exemplary process of calculating the image principal point by the camera parameter calculation device 1 according to the embodiment.

### Step S201

The acquisition part 11 acquires an image taken by the camera 2 and stores it in the frame memory 12.

### Step S202

The camera parameter calculation part 13 reads out the image acquired in Step S201 from the frame memory 12, and inputs the read-out image to the learning model that has been trained and stored in the learning model storage part 17 to thereby generate a heatmap.

### Step S203

The camera parameter calculation part 13 calculates an image principal point from the heatmap generated in Step S202. The camera parameter calculation part 13 calculates a pixel having the highest image principal point probability in the heatmap generated in Step S202 as the image principal point.

### Step S204

The camera parameter output part 14 outputs the image principal point calculated in Step S203 to, e.g., the camera 2.

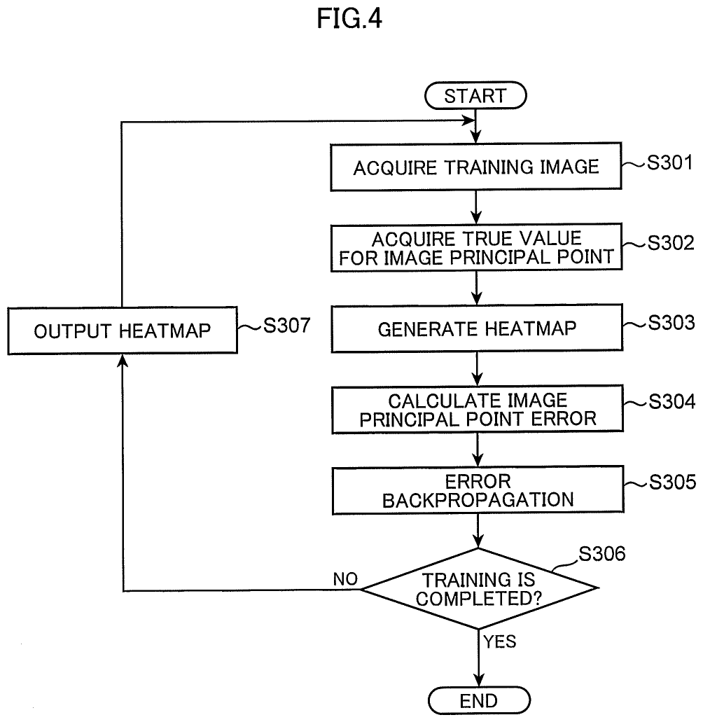

Next, a way of training the learning model will be described. FIG. 4 is a flowchart showing an exemplary training process of the camera parameter calculation device 1 according to the embodiment.

### Step S301

The image acquisition part 15 acquires a training image to be used for machine learning of the learning model. The training image is an image taken by the camera 2 in advance, or may be an image generated by using computer graphics processing.

### Step S302

The training part 16 acquires a true value for the image principal point. The true value for the image principal point is data associated with the training image. The true value for the image principal point represents an image principal point of the camera 2 that has taken the training image, or may represent an image principal point used for computer graphics processing.

### Step S303

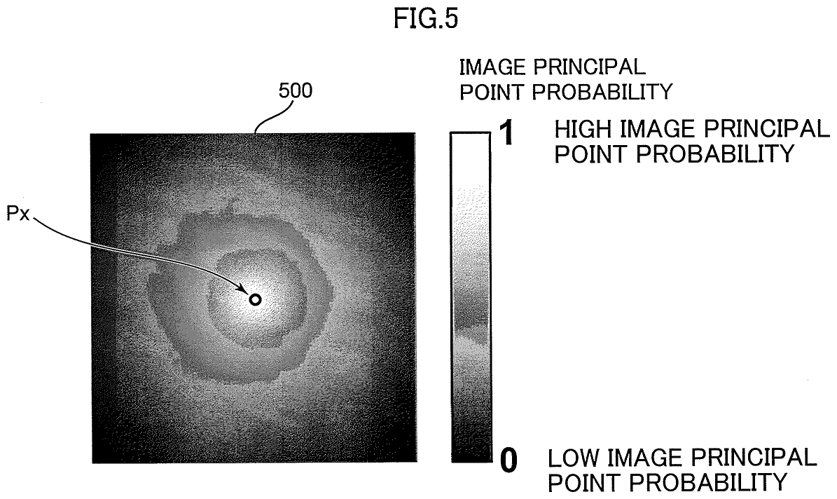

The training part 16 generates a heatmap by inputting the training image acquired in Step S301 to the learning model. FIG. 5 is an illustration showing an exemplary heatmap 500. As shown in FIG. 5, the heatmap 500 in the embodiment is a graph that visualizes a distribution of image principal point probabilities using colors and a gradation, specifically, an image that represents the image principal point probability having a value from 0 to 1 for each pixel. The example of FIG. 5 shows a pixel having a higher image principal point probability with a higher luminance and a pixel having a lower image principal point probability with a lower luminance. Contrary to the example of FIG. 5, a pixel having a higher image principal point probability may be shown with a lower luminance, i.e., the relationship between the image principal point probability and the luminance in the visualized heatmap 500 as shown in FIG. 5 may be reversed, because estimation around the center representing a high image principal point probability is enough to estimate the image principal point.

The training part 16 may train the learning model by machine learning using a partial region of the heatmap 500 instead of the entire heatmap. Using a narrower region of the heatmap 500 reduces a calculation cost of the machine learning. The calculation cost is almost proportional to the number of pixels of a heatmap to be used. Using an annular region having a specific number of pixels in the heatmap results in a higher accuracy than using another region having the specific number of pixels, because an increase in the number of pixels on a certain circumference causes an effect of noise reduction in a calculation of an average for the circumference in the heatmap. In other words, the training part 16 can perform efficient machine learning of the learning model by selecting pixels on an annular region in the heatmap 500.

Image distortions become smaller with approach to the image principal point Px and become larger with radial distance from the image principal point Px. Image distortions are equivalent to each other at such positions that distances from the image principal point Px (i.e., image heights) are equal to each other. Thus, a pixel with a large distortion indicates a low image principal point probability and a pixel with a small distortion indicates a high image principal point probability.

### Step S304

The training part 16 calculates an image principal point error on the basis of the heatmap generated in Step S303 and the true value for the image principal point Px acquired in Step S302. The details of the process in Step S304 will be described later.

### Step S305

The training part 16 updates a parameter of the deep neural network constituting the learning model to reduce the image principal point error calculated in Step S304. The error backpropagation can be optimized by use of, e.g., the stochastic gradient descent.

### Step S306

The training part 16 determines whether the training of the learning model has been completed. For example, whether the training has been completed is determined according to whether the number of updates of the parameters of the deep neural network constituting the learning model exceeds a threshold. The threshold is, e.g., 10,000 times, but this is merely an example and the threshold is not particularly limited thereto. In a case where the training is determined to have been completed (YES in Step S306), the process ends; in a case where the training is determined not to have been completed (NO in Step S306), the process proceeds to Step S307.

### Step S307

The heatmap output part 18 displays the heatmap generated in Step S303 on the display 3. Thus, a heatmap generated by the learning model in the training is presented to the user. A heatmap in the beginning of the training does not represent image principal points concentrically. However, as the training progresses, a heatmap representing image principal points concentrically is generated. Thus, the user having looked at the heatmaps can confirm the progress of the training.

When Step S307 is ended, the process returns to Step S301 and procedures in Steps S301 to S305 are executed for a next training image.

Next, the process of calculating the image principal point error in Step S304 will be described.

The training part 16 calculates the image principal point error J (H, Cx, Cy) on the basis of the heatmap H generated in Step S303 and the true value (Cx, Cy) for the image principal point. The image principal point error J (H, Cx, Cy) is represented by the equation (1).

$$\begin{matrix}[ Formula 1 ] & \\ J ( H , {C}_{x} , {C}_{y} 〉 = {\sum }_{r = 0}^{R} {\sum }_{θ = 0}^{2 π} {( ε ( r , θ , H , {C}_{x} , {C}_{y} ) - {ε}^{′} ( r , H , {C}_{x} , {C}_{y} ) )}^{2} & ( 1 )\end{matrix}$$

ε(r, θ, H, Cx, Cy) denotes the image principal point probability for a pixel of interest (r, θ) in a polar coordinate system having a center represented by the true value (Cx, Cy) for the image principal point. The pixel of interest is a certain pixel of the pixels forming the training image. A way of calculating the image principal point probability ε(r, θ, H, Cx, Cy) will be described. The image principal point probability ε(r, θ, H, Cx, Cy) for a rectangular coordinate (x, y) in the image having the origin at the upper left thereof can be calculated as the heatmap H (x, y). Using the polar coordinate (r, θ), a conversion of the rectangular coordinate (x, y) in the image having the origin at the upper left thereof is represented by: x=r·cosθ+Cx, y=r·sinθ+Cy. ε′(r, H, Cx, Cy) denotes an average image principal point probability for an image height r. In other words, the average image principal point probability ε′(r, H, Cx, Cy) is an averaged value of image principal point probabilities at pixels on a circumference of a circle that has a center represented by the true value (Cx, Cy) for the image principal point and passes through the pixel of interest (r, θ). The image height r is a distance between the true value for the image principal point and the pixel of interest (r, θ). The image principal point error J (H, Cx, Cy) is expressed with Σ for numerical calculation. A step for the image height r is, e.g., one pixel, and a step for an argument θ is, e.g., one degree. R denotes a predetermined maximum value for the image height r. The image principal point error J (H, Cx, Cy) is a function that represents a total of squared errors for all of the pixels of the heatmap and involves all of the pixels of the heatmap to improve accuracy in calculation of the estimated image principal point.

Next, it will be described that minimizing the image principal point probability J (H, Cx, Cy) in the equation (1) causes the deep neural network to learn to output a heatmap indicative of the image principal point probability. Typically, parameters of a deep neural network model are initialized with random numbers from, e.g., normal distribution. Thus, an output by the deep neural network initialized with the random numbers is a pixel value that represents a random image principal point probability of 0 to 1 for each pixel of the heatmap. In this regard, the output pixel value can be kept within the range of 0 to 1 by using, e.g., a sigmoid function.

The training part 16 acquires the true value for the coordinate of the image principal point described in Step S302. As described above, ε′(r, H, Cx, Cy) in the equation (1) represents the average image principal point probability for the image height r. The image height r is obtained as a distance from the true value for the image principal point acquired in Step S302 to the pixel of interest (r, θ). The image height r meets the same definition as that used in the computer vision, which is a distance from the image principal point.

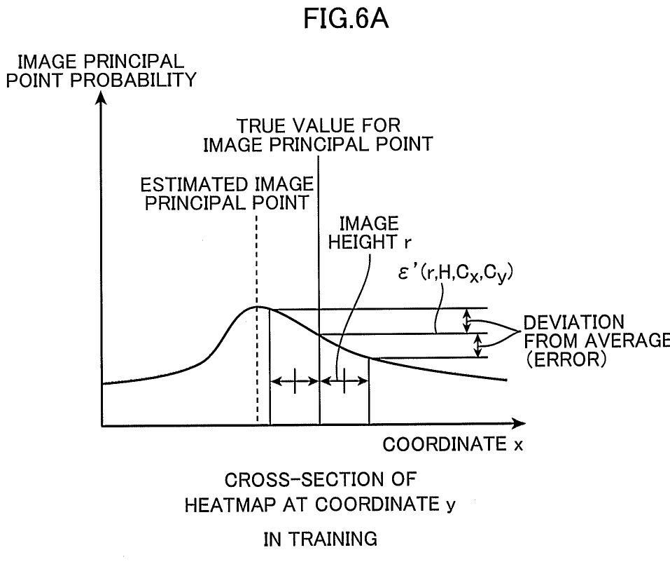

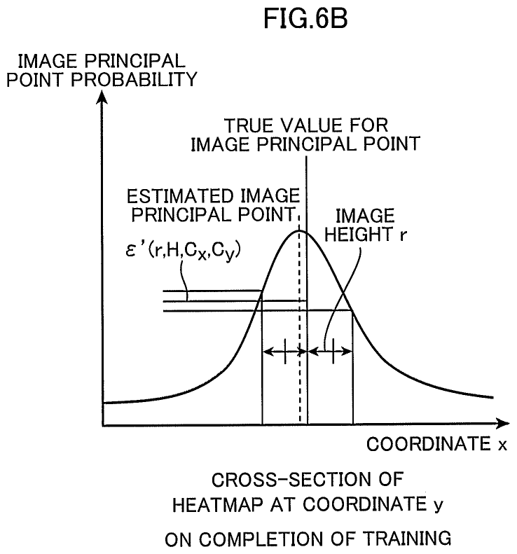

As the training to minimize the image principal point probability J (H, Cx, Cy) in the equation (1) progresses, the heatmap comes to indicate a high image principal point probability in a region close to the true value for the image principal point. Since the image height r represents the distance from the true value for the image principal point, a maximum of the image principal point probability in the heatmap comes to agree with the true value for the image principal point. On the completion of the training, the heatmap comes to indicate an axisymmetric distribution of image principal point probabilities with respect to an axis of symmetry represented by the true value for the image principal point, as shown in FIG. 6B. FIG. 6A is a graph showing an exemplary heatmap in the training. FIG. 6B is a graph showing an exemplary heatmap on completion of the training. In FIG. 6A and FIG. 6B, the vertical axis represents the image principal point probability, and the horizontal axis defines a cross-section of the heatmap at a coordinate y.

The area defined by the values for the image principal point probabilities and the x-axis in FIG. 6A is substantially equal to that in FIG. 6B. On the other hand, on the completion of the training (FIG. 6B), a deviation of image principal point probability from the average image principal point probability ε′(r, H, Cx, Cy) for an image height r is smaller than the deviation in the training (FIG. 6A). Therefore, on the completion of the training, the distribution of the image principal point probabilities in the heatmap is represented in a shape as shown in FIG. 6B. Thus, the trained deep neural network outputs a heatmap with concentric circles having a center represented by the image principal point Px, as shown in FIG. 5.

In a case where all of the pixels of the heatmap indicate zero, the image principal point error J (H, Cx, Cy) takes the minimum, i.e., zero. However, such a case does not occur in ordinary training because most of the parameters of the deep neural network are required to become zero in order that the outputs for all of the pixels by the deep neural network initialized with the random numbers become zero. Further, the image principal point error J (H, Cx, Cy) is not designed with an intention to set a scale to a certain value. Therefore, the average of the image principal point probabilities for all of the pixels of the heatmap changes little through the training, and the shape representing the distribution of the image principal point probabilities changes. Additionally, since the pixel indicative of the highest image principal point probability is selected as the pixel indicating the coordinate of the estimated image principal point, influence on the coordinate of the estimated image principal point due to the scale (constant multiplication of all the pixels) of the heatmap is ignorable.

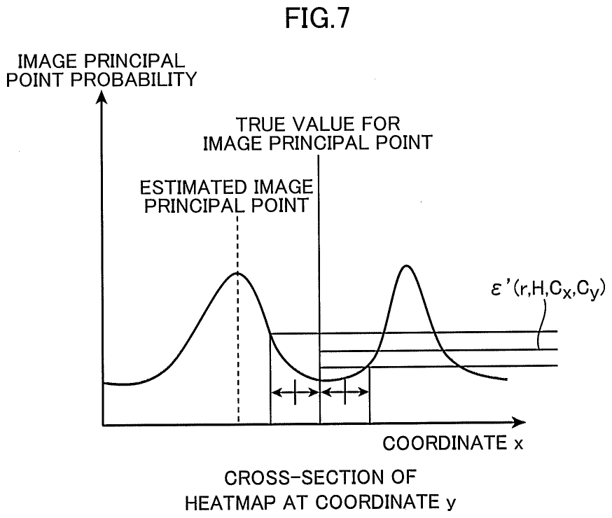

FIG. 7 is a graph showing an exemplary multipeaked heatmap. The multipeaked heatmap has a circular region indicative of a high image principal point probability in addition to a peak involving the maximum of the image principal point probability. The multipeaked type as shown in FIG. 7 indicates a small image principal point error J (H, Cx, Cy) represented in the equation (1). However, the multipeaked type indicates a large image principal point error J (H, Cx, Cy) in a case where a center of a circle indicative of the high image principal point probability deviates from the true value for the image principal point. Therefore, the multipeaked type may be temporarily output in the training, but is no longer output on the completion of the training. Thus, a heatmap having a single peak as shown in FIG. 5 is output.

A deep neural network to estimate an x-coordinate and a y-coordinate of the image principal point by direct regression can be built. However, the deep neural network involves output noise; the output noise decreases the accuracy for the coordinate of the image principal point. On the other hand, use of the heatmap indicative of the image principal point probability involves many pixels in the estimation of the coordinate of the image principal point. Thus, the output noise included in the heatmap is reduced and the image principal point is estimated with high accuracy. For example, if the maximum of the image principal point probability does not agree with the true value for the image principal point but there is a pixel indicative of the highest image principal point probability in the vicinity of the pixel representing the true value for the image principal point in the heatmap, a coordinate of the image principal point that is substantially equal to the true value for the image principal point can be obtained.

In this regard, in the case as described above where the image principal point is estimated by setting a pixel of interest within the annular region in the heatmap 500, the training part 16 sets a range of r in the equation (1) to be from r1 to r2 (<R).

In the equation (1), the image principal point error J (H, Cx, Cy) is represented by a squared error between ε(r, θ, H, Cx, Cy) and ε′(r, H, Cx, Cy), but this is merely an example; it may be represented by, e.g., a Huber loss between ε(r, θ, H, Cx, Cy) and ε′(r, H, Cx, Cy). The Huber loss gives a loss that is represented as a squared error for an absolute error of less than 0.5 and as a linear error for an absolute error of not less than 0.5. Other various ways of expressing an error can be used for expressing the image principal point error J (H, Cx, Cy), e.g., an absolute error between ε(r, θ, H, Cx, Cy) and ε′(r, H, Cx, Cy).

In Step S203 in FIG. 3, an x-component and a y-component of the image principal point are both estimated, but this is merely an example. The camera parameter calculation part 13 may estimate one of the x-component and the y-component of the image principal point only and use a design value for the other. In this case, the design value for the x-component is represented by a coordinate indicative of ½ of a width (x-component) of the image, and the design value for the y-component is represented by a coordinate indicative of ½ of a height (y-component) of the image.

Next, effects of the embodiment will be described with reference to FIG. 5. The heatmap 500 has an image size equal to that of the input training image, and pixels each of which has a luminance according to the image principal point probability. The heatmap 500 represents an ideal heatmap. Therefore, the heatmap 500 has the image principal point Px at the center thereof, and indicates a lower image principal point probability with distance from the image principal point Px. In other words, the heatmap 500 has the pixel indicative of the highest image principal point probability at the center thereof, and indicates a concentric distribution of the image principal point probabilities.

Practically, many heatmaps generated by the learning model contain noise, and thus do not always indicate a precisely concentric distribution of the image principal point probabilities.

In the embodiment, the learning model is trained by machine learning by use of the image principal point error J (H, Cx, Cy) as shown in the equation (1). In other words, the learning model is trained by machine learning so as to cause the estimated image principal point to approach the true value for the image principal point, in consideration of the distribution of the image principal point probabilities indicated by the heatmap. Therefore, a learning model can be obtained that can accurately estimate the image principal point Px regardless of some pixels in the heatmap which incorrectly represent the image principal point error. Consequently, the embodiment enables more highly accurate estimation of the image principal point Px, in comparison with a regression method to directly obtain the image principal point Px by inputting an image to a learning model. Thus, the embodiment enables highly accurate estimation of the image principal point from an image.

### Modifications

In the present disclosure, the following modifications may be implemented.
(1) In the embodiment above, the image principal point probability serves as the likelihood at each pixel constituting the heatmap, but this is merely an example. A magnitude of distortion of the image may serve as the likelihood at each pixel constituting the heatmap. The image principal point serves as a reference position representing a distortion of zero in a camera model representing symmetry with respect to the optical axis. In other words, the image principal point can be estimated similarly to the first embodiment by estimating the magnitude of distortion instead of the image principal point probability.
(2) In a case where the embodiment above further involves an additional camera parameter as well as the image principal point, the training part 16 trains the learning model by using a training image associated with the additional camera parameter as well as the image principal point. The additional parameter includes, e.g., the parameter indicative of the rotation angle of the camera 2, the parameter indicative of the translation of the camera 2, and the pixel pitch of the image sensor of the camera 2, which are described above.
(3) The camera parameter calculation device 1 according to one or more aspects of the present disclosure is described above with reference to the embodiment, but the present disclosure is not limited to the embodiment. Various modifications conceivable by one skilled in the art and a combination of constituents in different embodiments are included within the scope of the one or more aspects of the present disclosure as long as those do not deviate from the concept of the present disclosure.

The camera parameter calculation device of the present disclosure is useful for camera calibration.

1. A camera parameter calculation device comprising:
an acquisition part for acquiring an image taken by a camera; and
a camera parameter calculation part for generating a heatmap representing a likelihood of image principal point at each pixel by inputting the image acquired by the acquisition part to a learning model, and calculating a camera parameter of the camera on the basis of the generated heatmap, wherein
the learning model is trained by machine learning so as to cause an estimated image principal point indicated by a heatmap generated from an input training image to approach a true value corresponding to the estimated image principal point.

2. The camera parameter calculation device according to claim 1, further comprising:
a camera parameter output part for outputting the camera parameter calculated by the camera parameter calculation part.

3. The camera parameter calculation device according to claim 1, wherein the learning model is trained by machine learning so as to output a heatmap having a concentric distribution of the likelihoods.

4. The camera parameter calculation device according to claim 1, wherein the learning model is trained by machine learning so as to minimize a difference between a likelihood at a pixel of interest and an average value of likelihoods at pixels on a circumference of a circle that has a center represented by the true value and passes through the pixel of interest.

5. The camera parameter calculation device according to claim 1, further comprising:
a heatmap output part for outputting to a display a heatmap output by the learning model which is in the training of the learning model.

6. The camera parameter calculation device according to claim 1, wherein the likelihood includes an image principal point probability or a distortion.

7. The camera parameter calculation device according to claim 1, wherein the camera parameter includes the image principal point.

8. A camera parameter calculation method, by a computer, comprising:
acquiring an image taken by a camera; and
generating a heatmap representing a likelihood of image principal point at each pixel by inputting the acquired image to a learning model, and calculating a camera parameter of the camera on the basis of the generated heatmap, wherein
the learning model is trained by machine learning so as to cause an estimated image principal point indicated by a heatmap generated from an input training image to approach a true value corresponding to the estimated image principal point.

9. A non-transitory computer readable recording medium storing a camera parameter calculation program causing a computer to execute a process of:
acquiring an image taken by a camera; and
generating a heatmap representing a likelihood of image principal point at each pixel by inputting the acquired image to a learning model, and calculating a camera parameter of the camera on the basis of the generated heatmap, wherein
the learning model is trained by machine learning so as to cause an estimated image principal point indicated by a heatmap generated from an input training image to approach a true value corresponding to the estimated image principal point.
